(19) United States
(12) Patent Application Publication
(10) Pub. No.: US 2018/0233045 A1
(43) Pub. Date: Aug. 16, 2018

(54) END-TRIP DETECTION SYSTEM

(71) Applicant: Vikram Kumar, Flitch Green Dunmow (GB)

(72) Inventor: Vikram Kumar, Flitch Green Dunmow (GB)

(21) Appl. No.: 15/488,476

(22) Filed: Apr. 15, 2017

(30) Foreign Application Priority Data
Feb. 10, 2017 (IN) 201711004898

(51) Int. Cl. G08G 1/123; G01C 21/00; G01C 21/28

(52) U.S. Cl. CPC G08G 1/123; G08G 1/20; G01C 21/28; G01C 21/005

(57) ABSTRACT

A system including a first device having one or more ports and a location sensor and a server in communication with the first device to receive inputs from the first device is disclosed. In the system, the server is configured to determine whether a trip has terminated on the basis of the inputs from the first device and a second device.

### CROSS-REFERENCES TO RELATED APPLICATIONS

This patent application claims priority to Indian Patent Application No. 201711004898 filed on Feb. 10, 2017 for Vikram Kumar, the entire contents of which are incorporated herein by reference for all purposes.

### FIELD

The present disclosure relates to a processing system, specifically, the present disclosure relates to an end-trip detection system.

### BACKGROUND

Technology has enabled varied features to be incorporated to render a hassle free and safe ride service. Such features include SOS buttons for women safety, real-time tracking of rides, identification of nearby vehicles for a ride, etc. Constant efforts are invested in modifying/upgrading these features to provide a comfortable, safe and secure ride for passengers and drivers both.

However, there is still no mention about an automated system for trip end detection and the like for detection end of a ride. There is thus a need for a solution to various problems relating to reimbursement, attendance etc. and/or an authentic and sound detection system in vehicles.

### SUMMARY

In accordance with an embodiment of the present disclosure, a system includes a device A having one or more ports and a location sensor and a server in communication with the device A to receive inputs from the one or more ports and the location sensor. The server is configured to determine whether the inputs from the ports are received within a predefined time duration and thereafter determine termination of a trip on the basis of the inputs from the location sensor of at least the device A.

In accordance with an embodiment of the present disclosure, a system includes a device A having one or more ports and a location sensor. The device A is configured to determine whether the inputs from the ports are received within a predefined time duration. A server communicates with the device A to receive inputs from the location sensor. The server is configured to determine termination of a trip on the basis of the inputs from the location sensor of at least the device A.

In accordance with an embodiment of the present disclosure, a method includes the steps of receiving data from two or more ports, determining whether the data received from the ports is within a predefined time duration at a server, requesting location coordinates of device A and device B, and determining whether the distance between the location coordinates of the device A and device B are beyond a threshold distance, thereby terminating a trip.

In accordance with an embodiment of the present disclosure, a method includes the steps of receiving signals via two or more ports provided in a device A, determining whether the signals of the port are received within a predefined time duration at the device A, transmitting an alert to a server to initiate processing of trip termination procedure and transmitting a location of the device A to the server for determination of trip termination.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale. Wherever possible, like elements have been indicated by identical numbers.

FIG. 1A is a system configured as a client/server architecture used in an embodiment of the present invention.

FIG. 1B depicts an alternate embodiment of the client-server architecture of the present invention.

FIG. 2 shows an exemplary embodiment of device A.

FIG. 3 illustrates the plurality of modules possessed by the termination system 50 of the application server 10.

FIG. 4A illustrates an exemplary embodiment of the present invention in which the present invention is employed for end trip detection.

FIG. 4B illustrates an alternate embodiment to FIG. 4A.

FIG. 5 represents subsequent steps of FIG. 4A and FIG. 4B.

### DETAILED DESCRIPTION OF ILLUSTRATIVE EMBODIMENTS

Methods and systems for detecting end of a trip are disclosed. The following description is presented to enable any person skilled in the art to make and use the invention. For purposes of explanation, specific nomenclature is set forth to provide a thorough understanding of the present invention. Descriptions of specific applications are provided only as examples. Various modifications to the preferred embodiments will be readily apparent to those skilled in the art, and the general principles defined herein may be applied to other embodiments and applications without departing from the spirit and scope of the invention. Thus, the present invention is not intended to be limited to the embodiments shown, but is to be accorded the widest scope consistent with the principles and features disclosed herein.

The embodiments are described below with reference to block diagrams and/or data flow illustrations of methods, apparatus, systems, and computer program products. It should be understood that each block of the block diagrams and/or data flow illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the data flow illustrations or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the data flow illustrations or blocks.

Accordingly, blocks of the block diagrams and data flow illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

Further, applications, software programs or computer readable instructions may be referred to as components or modules. Applications may be hardwired or hardcoded in hardware or take the form of software executing on a general purpose computer such that when the software is loaded into and/or executed by the computer, the computer becomes an apparatus for practicing the invention, or they are available via a web service. Applications may also be downloaded in whole or in part through the use of a software development kit or a toolkit that enables the creation and implementation of the present invention. In this specification, these implementations, or any other form that the invention may take, may be referred to as techniques. In general, the order of the steps of disclosed processes may be altered within the scope of the invention.

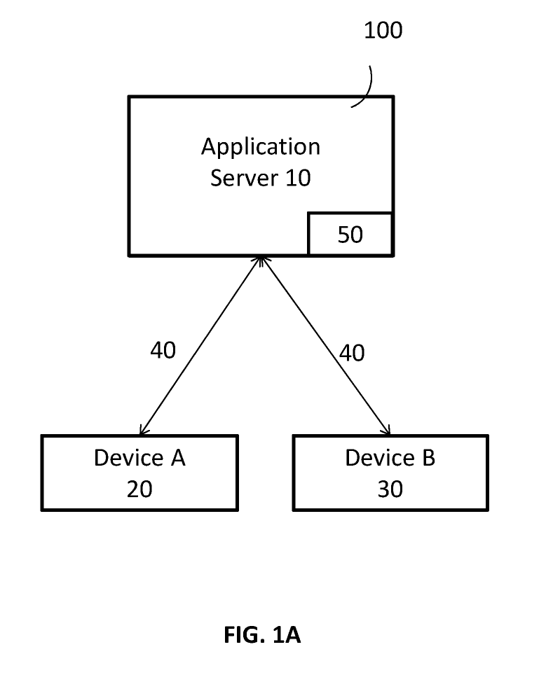

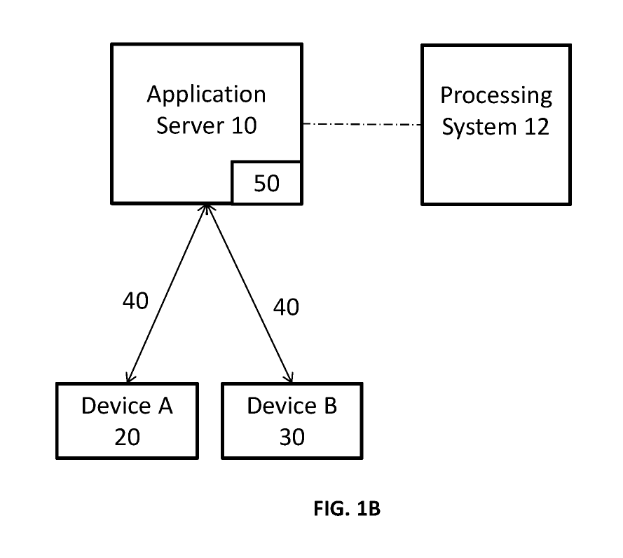

Referring now to the drawings, FIG. 1A is a system 100 configured as a client/server architecture used in an embodiment of the present invention. A “client” is a member of a class or group that uses the services of another class or group to which it is not related. In the context of a computer network, such as the Internet, a client is a process (i.e. roughly a program or task) that requests a service which is provided by another process, known as a server program. The client process uses the requested service without having to know any working details about the server program or the server itself. In networked systems, a client process usually runs on a computer that accesses shared network resources provided by another computer running a corresponding server process.

A “server” is typically a remote computer system that is accessible over a communication medium such as the Internet. The client process may be active on a second computer system, and communicate with the server process over a communication medium that allows multiple clients to take advantage of the information-gathering capabilities of the server. Thus, the server essentially acts as an information provider for a computer network.

In FIG. 1A, the system 100 for practicing the teachings of the present disclosure, as per an embodiment, includes an application server 10, a device A 20 and a device B 30, any two of which exchange data through network 40.

The application server 10 may include a termination system 50 which obtains inputs from device A 20 and/or device B 30 and further processes the obtained inputs. A software application may be installed on either or both the devices 20, 30. The software application may find applications in, without limitation, attendance management, tracking and other ride related reports, etc.

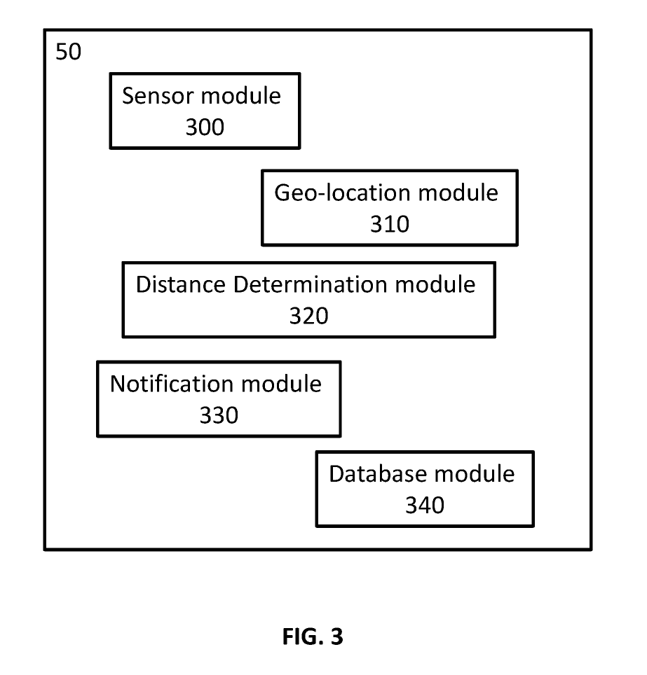

In an embodiment, the termination system 50 receives location as well as sensor inputs from the device A 20 while only location inputs from device B 30. The detailed architecture of the server 10 hosting the termination system 50 is described in FIG. 3. In an embodiment, the server 50 may be a cloud based server. As stated above, the server may be a remote computer system having processing capability engaged by the termination system.

Device A 20 communicates with the server 10 to transmit details such as location co-ordinates, sensor signals, etc. to the application server 10. Device A 20 may be located in/on an object for example, a vehicle whose details are to be transmitted. Device A 20 may include a GPS receiver, a Wi-Fi positioning data device, or other network based devices capable of determining location by performing calculations on radio signals transmitted to and from the device. For example, the device A 20 may receive global positioning system (GPS) data from one or combination of global navigation satellite system (GNSS), GLONASS, Galileo or Beidou, etc. and process the received data to produce location coordinates. Device A 20 may transmit such location co-ordinates via the network 40 or combination of networks 40 such as cellular network or other packet switched network such as Wi-Fi, Internet, etc. to the application server 10. Alternately, device A 20 may transmit one or more updates related to the sensor output to the server 10. In various embodiments, device A 20 may transmit aforementioned details at regular predefined intervals (e.g. 2 mins, 5 mins, etc.) or at/after a predetermined event for example, halting of a vehicle, opening of a door, etc.

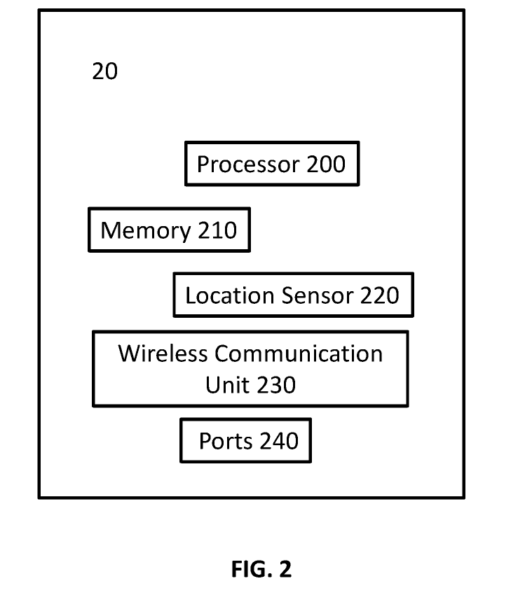

In addition, device A includes one or more ports to receive various inputs from respective sensors associated with the object. Further, embodiments of device A 20 may include fewer components, additional components, or some of the components may be integrated with one another (elaborated in FIG. 2).

Device B 30 is a client computer which can be a laptop, a handheld device such as a mobile phone, a cell phone, a smartphone, a personal digital assistant (PDA), a tablet, etc., a wearable device like a smart watch, a NFC device, etc. A software application may be installed on the device B which may be similar or different to the one installed on device A. As an example, device B may be a device held by the passenger of a vehicle. Device B 30 may include one or more processors, memories, input/output devices, and a network interface, such as a conventional modem. Further, device B 30 may include location detection capability for example, a GPS receiver, assisted GPS, WiFi networks, etc. Device B 30 may communicate with the server via network 40 bi-directionally.

Network 40 includes without limitation the Internet, a local area network, a wide area network and/or a wireless network. The network 40 may comprise copper transmission cables, optical transmission fibres, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

FIG. 1B depicts an alternate embodiment of the client-server architecture of the present invention. In addition to the environment of FIG. 1A, in FIG. 1B, the application server 10 may communicate with a processing system 12. The processing system 12 may be a third-party server or any concerned device which may be without limitation, a laptop, a mobile phone, a tablet, etc. which requests for the services of the application software of the application server 10. The processing system 12 may access the functionality/feature(s) via a browser, software application, widget, plugin, etc. The application server 10 may transmit the requested data in the form of reports pertaining to attendance, average time spent, average speed, SOS data, etc. Additionally and optionally, the application server 10 may transmit SOS alerts, audio alerts, vibration alerts, etc.

FIG. 2 shows an exemplary embodiment of the device A 20 having a processor 200 coupled to a memory 210, a location sensor 220, a wireless communication unit 230, and one or more ports 240. The processor 200 may include firmware, hardware, and software, in various combinations.

The processor 200 decodes and stores analog/digital inputs received from vehicle sensors via one or more ports 240 and presents data for transmission to the wireless communication unit 230. The processor 200 may optionally process these inputs before transmitting the same to the application server 10.

The location sensor (say, GPS receiver) 220 may be coupled to a GPS antenna (not shown), which receives GPS data from one or more GPS satellites. This received GPS data may be processed by the location sensor 220 to produce the location co-ordinates. Alternately, the location sensor 220 may receive the latitude/longitude coordinates and calculate the location of the device A. Or, triangulation may be used in connection with various cellular towers positioned at various locations throughout a geographic area in order to determine the location of the device A. The location sensor 220 may be used to receive position, and time, which may be used to compute speed. As will be appreciated from the description herein, more than one location sensor 220 may be utilized, and other similar techniques may likewise be used to collect geo-location information associated with the device A.

The wireless communication unit 230 enables communication between the device A and the application server 10 via known protocols like HTTP Secure (HTTPS), Hypertext Transfer Protocol (HTTP) etc.

The port(s) 240 are coupled to respective sensors and receive data from respective sensors installed in the vehicle. In an embodiment, various sensors may be installed in the vehicle, which are wired to the respective port 240 of device A. In an alternate embodiment, the sensors may be coupled to respective port of device A wirelessly. The port 240 receives updated information from the respective sensor and further communicates it to the processor 200. For example, the port in communication with a door detects opening or closing of a door on the basis of passage of current via it.

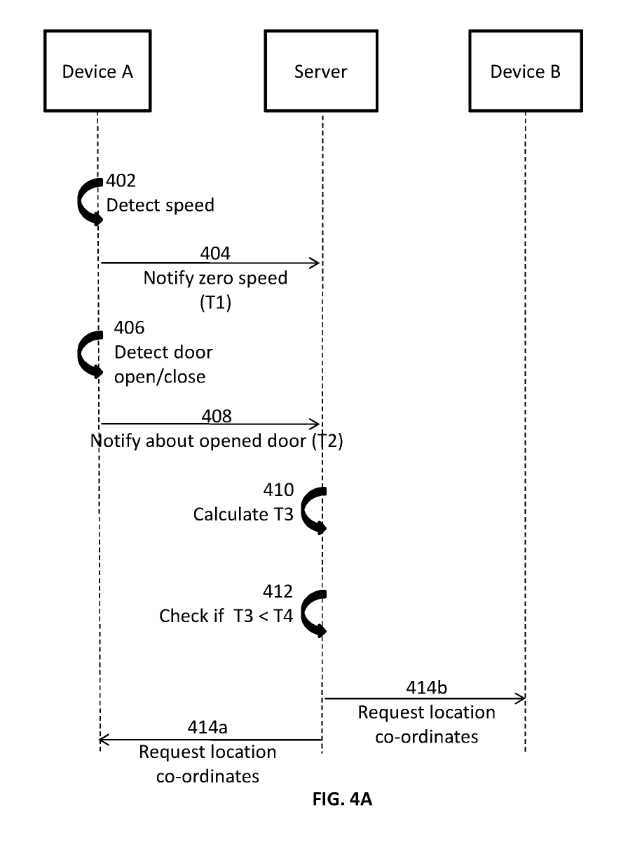

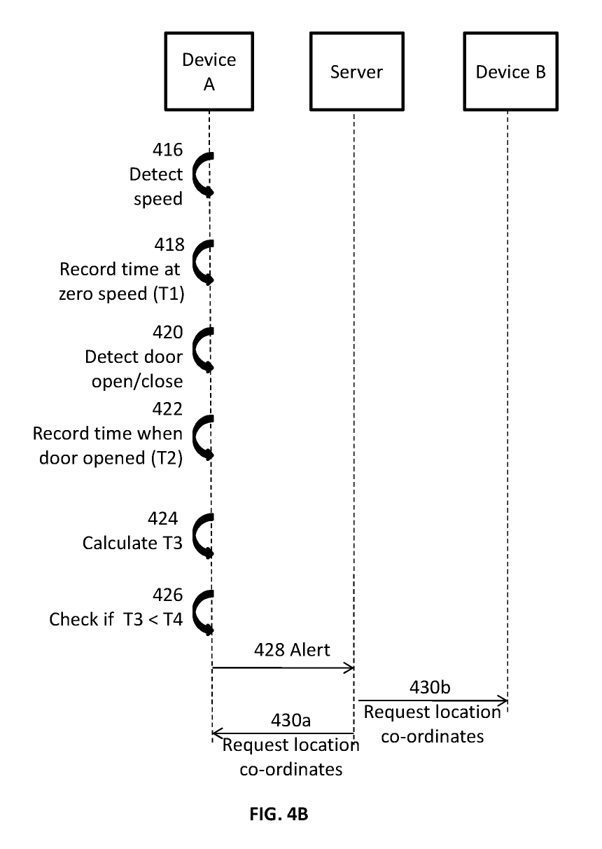

In various embodiments, the device A may be configured to capture and store data from the vehicle sensors at predefined time intervals and/or in response to detecting the occurrence of one or more of a plurality of predefined vehicle events. A predefined time interval may be 5 mins, 10 mins, etc. or configured as desired while vehicle events may be a passenger vacating a seat, opening of a door, etc. Generally, a vehicle event may be defined as a condition relating to any parameter or combination of parameters measurable by the one or more vehicle sensors. Alternately, the device A may be configured to continuously monitor the various vehicle sensors and detect when the data generated by the one or more vehicle sensors indicates one or more of the plurality of predefined vehicle events as explained below from FIG. 4 onwards. In response to detecting a vehicle event, the device A captures data from all of the vehicle sensors or a particular subset of the vehicle sensors associated with the detected vehicle event.

As stated above, various sensors are employed in a vehicle for generating vehicle data. For example, in one embodiment, the vehicle includes sensors configured to make measurements and capture data pertaining to the following vehicle dynamics: vehicle speed (e.g., kms per hour), vehicle door status (e.g., open or closed), vehicle location (e.g., latitude and longitude), distance traveled (e.g., kms between two points), etc. In various other embodiments, the vehicle may include any combination of the above-referenced sensors (and additional sensors known in the art) depending on the operational data desired by the application server 10.

According to various embodiments, the vehicles sensors disposed within the vehicle comprise on/off sensors, which register a voltage amount that corresponds with an on/off condition. For example, one or more door position sensors may be connected, for example, to the driver side, passenger side, and bulkhead doors, and may register 0V when the door with which the sensor is associated is in an open position, and 5V when the door is in closed position.

Alternately, the vehicle sensors disposed within the vehicle comprise variable voltage sensors, which may be used to register variations in voltage reflecting a certain vehicle dynamic. For example, vehicle speed sensors, or vehicle location sensors.

The exemplary vehicle sensors described above may be configured, for example, to operate in a desired fashion to generate computer-readable data that may be captured, stored, and transmitted by device A 20. In addition, while certain sensors are preferably disposed at particular locations on or within the vehicle (e.g., door position sensors at the doors), other sensors may be disposed anywhere within the vehicle (e.g., a location sensor). For example, seat sensors may be installed anywhere (on, below or sides) in relation to the seats of the concerned vehicle. The seating sensor detects pressure applied to the seat to conclude whether the passenger is seated or not. The types of sensors explained above are exemplary and various other sensors can be deployed as alternative or additional sensors.

FIG. 3 illustrates the plurality of modules of the termination system 50 of the application server 10. In an embodiment of the present invention, the application server 10 performs various functions including event based determination of distance between the locations of two devices (A and B). The application server 10 may push one or more prescribed messages in form of for example, a short messaging service (SMS), a push notification (alert or update), a phone call via server and/or other forms of electronic communications in order to notify the trip end event to the passenger and/or driver. It should be noted that other ways of determining location coordinates may be used along with the teachings of the present disclosure.

The application server 10 as shown in FIG. 3 has the following modules: a sensor module 300, a geo-location module 310, a distance determination module 320, a notification module 330, a database 340 and a time determination module 350.

The sensor module 300 may receive sensor inputs detected by the device A 20. In an embodiment of the present invention, the sensor module 300 receives the data of two or more sensors via the port 240 of device A sequentially or collectively.

The geo-location module 310 may receive location co-ordinates from one or more of the device A 20 and/or device B 30. The geo-location module 300 may receive the location co-ordinates in real-time or as per configured durations, e.g. 2 minutes or at a configured event, say when the object is halted and a door is opened.

The distance determination module 320 may operate in communication with the geo-location module 310. In an embodiment, the distance determination module 320 calculates the distance between the location co-ordinates of the device A 20 and device B 30. The distance determination module 320 decides whether a trip/ride is to be terminated depending upon the calculated distance between the device A 20 and device B.

The notification module 330 may be configured to trigger one or more notifications to device A 20 and/or device B 30 and/or the processing system 12. For example, a notification is sent to device B 30 when the trip is successfully terminated. The notification may be in the form of without limitation, a push message or an audio call.

The database 340 may store various inputs received from device A 20 and/or device B 30. It may also include one or more look up tables of features that the subscriber may have subscribed. The list of features includes without limitation type of notifications, templates of reports like invoicing template, attendance reports, etc. analysis, event based triggers, etc.

The time determination module 350 may operate using the inputs obtained from the sensor module 300. The time determination module 350 further processes the time details obtained from the sensor module 300 to target concerned applications. In an embodiment, the time determination module 350 determines the difference in time between the stopping of the vehicle and opening of a door. If the time difference is found to be in a predefined range say 2 mins, further processing may continue.

FIG. 4A illustrates an exemplary embodiment of the present invention for an end trip detection. As stated above, devices A and B have location sensing and transmitting capability. In addition, device A may possess without limitation sensing capabilities.

At step 402, the device A periodically or constantly monitors the speed of the vehicle. The device A detects zero speed of the vehicle. For example, device A may calculate the speed using two consecutive latitude and longitude co-ordinates and the time elapsed between the two. Device A subsequently notifies the application server about zero speed detection with the time at which zero speed is attained (T1) at step 404. The termination system of the application server may possess different modules for receiving and processing the input details obtained from device A.

At step 406, the door position sensor of the device A detects the movement of one or more door(s) of the vehicle and registers the opening of the door. In an embodiment, the door position sensor monitors the movement of passenger doors. The door position sensor may detect flow of current when the respective door is opened. Optionally, the seat sensor detects presence/absence of one or more occupants in the vehicle.

At step 408, device A notifies the application server when the passenger door is opened with the time at which the door(s) is opened (T2). In an embodiment of the present invention, door position sensor operates along with the seat sensor. For example, the application server is notified about opening of the door only when the device A senses a change in the state of the seat sensor and the door position sensor. For example, change in the state of the seat sensor may be from 0 to 1 where 0 depicts a state in which a passenger is seated while 1 depicts a state in which a passenger vacates the seat. Or, the change in state may be ascertained due to passage of current through the port. In an alternate embodiment, the door position sensor may operate independently.

At step 410, the termination system of the application server calculates the difference between T1 and T2 (T2−T1=T3). The application server also stores a predetermined threshold time (T4). In an exemplary embodiment, T4 is 30 seconds. The threshold time is defined for the reason that if a vehicle halts at the traffic signal for a short duration, and the passenger door opens after a considerable time gap, say 30 mins, the application server should not identify it as a trip end event. Therefore, at step 412, T3 and T4 are compared and if T3 is found to be lesser than T4 then the subsequent steps are followed. Else, the application server 10 resets to 402.

At steps 414a & 414b, the application server requests for the location co-ordinates of device A and device B respectively. The application server may request the location co-ordinates from said devices simultaneously or at different times instantly after step 412 or followed by a few minutes wait after step 412. In an exemplary embodiment, the application server requests for location co-ordinates after 5 minutes. This time may vary as per configured settings.

In an embodiment of the present invention, devices A & B send their respective location co-ordinates as soon as the details are requested by the application server. Or, devices A & B may send location co-ordinates to the application server periodically, say every 5 minutes or on detection of movement or cellular switch, etc. In an embodiment, it is mandatory for device B to enable location detection capability/feature. There may also be a provision for real-time tracking of the devices A & B. In order to enable devices A & B to transmit location co-ordinates, a GPS receiver or its equivalent may be turned on. Devices A & B transmit the location co-ordinates to the application server via a network.

FIG. 4B illustrates an alternate embodiment to FIG. 4A. Device A in this embodiment includes without limitation, GPS and sensing capabilities. In an embodiment, device A is located inside the vehicle.

At step 416, the device A periodically or constantly monitors the speed of the vehicle. When the device A detects zero speed of the vehicle, it records the time at which zero speed is attained (T1) at step 418.

At step 420, the door position sensor of device A detects the movement of door(s) of the vehicle and recognizes it open/closed state. The door position sensor monitors the movement of passenger doors. The door position sensor monitors the movement of passenger doors. Optionally, the seat sensor detects presence/absence of one or more occupants in the vehicle.

At step 422, device A records the time at which the door(s) is opened (T2). In an embodiment of the present invention, door position sensor operates along with the seat sensors. In an embodiment, the device A notifies the application server when the passenger door is opened with the time at which the door(s) is opened (T2). Alternately, the device A notifies the application server about opening of the door only when the passenger seat(s) is vacated followed by detection of opening of a passenger door.

At step 424, device A calculates the difference between the recorded values of T1 and T2 (T2−T1) and subsequently records it as T3. At step 426, the values of T3 and a predetermined time threshold T4 are compared and if T3 is found to be lesser than T4 then the subsequent steps are followed.

At step 428, device A sends an alert to the application server for further action.

At steps 430a & 430b, the application server requests for the location co-ordinates of device A and device B respectively. The application server may request the location from the said devices simultaneously or at different times.

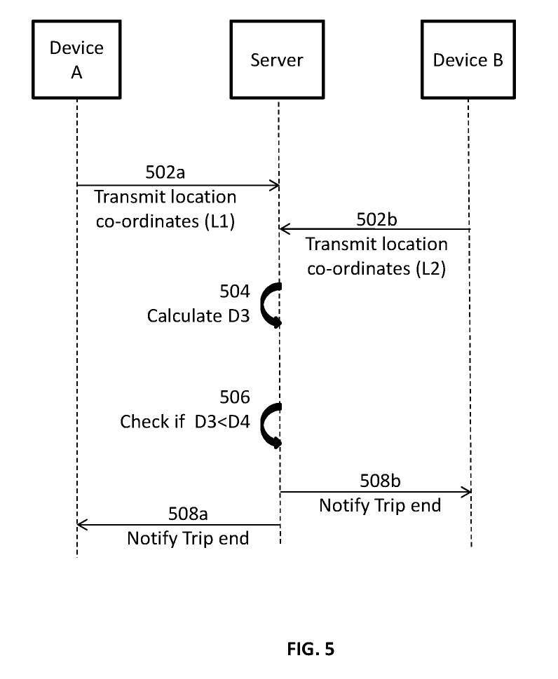

FIG. 5 represents subsequent steps of FIG. 4A and FIG. 4B. The location co-ordinates requested by the application server in the previous figures (FIG. 4A & FIG. 4B) are received and recorded by the application server at step 502. The location co-ordinates of device A are recorded as L1 while location co-ordinates of device B are recorded as L2. The geo-location module mentioned above may record the location data obtained from the said devices.

The distance determination module then calculates the distance between L1 and L2 (|L1−L2|) and records the distance as D3 at step 504. The application server includes a threshold distance D4 which the distance determination module of the application server uses for comparison of D3 and D4. At step 506, if the distance determination module determines that D3 is lesser than D4 then subsequent steps are followed. If D3 is more than D4 then trip end event is not executed.

At steps 508a & 508b, the application server notifies device A, device B and/or processing device about the end of the trip. The application server may also send web alerts to the devices A & B as well as to the processing system as configured. In an embodiment, the devices A & B as well as the processing system is notified about zero speed of the vehicle, door opening and trip end, etc.

Devices A & B may also include a software program configured to display/indicate one or more messages, notifications or alerts received from the application server by way of, for example, a vibration pattern, a sound, a voice alert, etc.

As should be appreciated from description above, the embodiments may be implemented in various ways, including as methods, apparatus, systems, or computer program products. Accordingly, the embodiments may take the form of an entirely hardware embodiment or an embodiment in which a processor is programmed to perform certain steps. Furthermore, the various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

No element, act, or instruction used in the description of the present disclosure should be construed as critical or essential to the invention unless explicitly described as such. Also, as used herein, the article “a” is intended to include one or more items. Where only one item is intended, the term “one” or similar language is used.

What is claimed is:

1. A system comprising:
a device A including one or more ports and a location sensor; and
a server in communication with the device A to receive inputs from the one or more ports and the location sensor, the server being configured to determine whether the inputs from the ports are received within a predefined time duration, the server being configured to thereafter determine termination of a trip on the basis of the inputs from the location sensor of at least the device A.

2. The system of claim 1, wherein the one or more ports communicate with at least one of a location sensor, a door position sensor and a seat sensor.

3. The system of claim 1, wherein the server communicates with a device B to obtain location of the device B.

4. The system of claim 1, wherein the server is configured to determine termination of the trip on the basis of location of the device A and device B when distance between the location of the device A and device B is greater than a threshold distance.

5. The system of claim 1, wherein the server is a cloud based server.

6. The system of claim 1, wherein the server is configured to generate one or more reports based upon at least one or more of actual speed, number of passengers, driver details, distance travelled, and duration.

7. A system comprising:
a device A including one or more ports and a location sensor, the device A being configured to determine whether the inputs from the ports are received within a predefined time duration; and
a server in communication with the device A to receive inputs from the location sensor, the server being configured to determine termination of a trip on the basis of the inputs from the location sensor of at least the device A.

8. The system of claim 7, wherein the one or more ports communicate with at least one of a location sensor, a door position sensor and a seat sensor.

9. The system of claim 7, wherein the server communicates with a device B to obtain location of the device B.

10. The system of claim 7, wherein the server is configured to determine termination of the trip on the basis of location of the device A and device B when distance between the location of the device A and device B is greater than a threshold distance.

11. The system of claim 7, wherein the server is a cloud based server.

12. The system of claim 7, wherein the server is configured to generate one or more reports based upon at least one or more of actual speed, number of passengers, driver details, distance travelled, and duration.

13. A method comprising:
receiving data from two or more ports;
determining whether the data received from the ports is within a predefined time duration at a server;
requesting location coordinates of device A and device B; and
determining whether the distance between the location coordinates of the device A and device B are beyond a threshold distance, thereby terminating a trip.

14. The method of claim 13, further comprising generating one or more reports by the server based upon at least one or more of actual speed, number of passengers, driver details, distance travelled, and duration.

15. A method comprising:
receiving signals via two or more ports provided in a device A;
determining whether the signals of the port are received within a predefined time duration at the device A;
transmitting an alert to a server to initiate processing of trip termination procedure; and
transmitting a location of the device A to the server for determination of trip termination.

16. The method of claim 15, wherein the receiving comprises receiving signals from a port to one or more doors of an object, a port to one or more seats of an object and/or a port to the speed sensor.

17. The method of claim 15, wherein the determining comprises:
determining zero speed of an object to which the device A is associated; and
determining whether one of the doors of an object is opened on the basis of an input received via the port.
